(19) United States
(12) Patent Application Publication
(10) Pub. No.: US 2009/0321424 A1
(43) Pub. Date: Dec. 31, 2009

(54) Cooking device

(75) Inventors: Miguel Angel Buñuel Magdalena, Zaragoza (ES); Jesús Ceamanos Gaya, Zaragoza (ES); Jose Antonio Garcia Herrer, Zaragoza (ES); Jose-Ramon Garcia Jimenez, Zaragoza (ES); Alfonso Lorente Perez, Zaragoza (ES)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgerate GmbH, Munchen (DE)

(21) Appl. No.: 12/310,954

(22) PCT Filed: Aug. 27, 2007
(86) PCT No.: PCT/EP2007/058869

§ 371 Date: Mar. 12, 2009

(30) Foreign Application Priority Data
Sep. 13, 2006 (ES) P200602959

(51) Int. Cl. H05B 6/12

(52) U.S. Cl. 219/620; 219/622

(57) ABSTRACT

A cooking device, in particular a cooking device for induction hobs, the cooking device including a computation unit, the computation unit having at least one standby mode that is activated as a function of a removal of cookware from a cooking zone; and a warning signal output unit, the warning signal output unit outputting, during a period in which the standby mode has been activated, a warning signal in the event that cookware is again within the cooking zone.

The invention relates to a cooking device as claimed in the preamble of claim 1. The invention further relates to a method as claimed in the preamble of claim 10.

A cooking device, in particular for induction cookers, comprising a computation unit which has at least one standby mode is already known. The standby monde is activated here when cookware is removed from a cooking zone.

The object of the invention consists in particular in providing a generic cooking device with improved properties in respect of increased safety for a user of the cooking device. The object is achieved in accordance with the invention by the features of claim 1, while advantageous embodiments and developments of the invention can be inferred from the subclaims.

The invention relates to a cooking device, in particular for induction cookers, comprising a computation unit, which has at least one standby mode, which is activated when cookware is removed from a cooking zone.

It is recommended that the cooking device has a warning signal output unit, which is provided to give off a warning signal after the cookware has been put back on the cooking zone when the standby mode is activated, as a result of which safety and convenience can be advantageously increased for a user of the cooking device. In addition, an advantageous information output to an user of the cooking device can be achieved in this way, by this indicating after cookware has been put back for instance that the cooking device and/or cooking zone of the cooking device is in a deactivated cooking mode and/or in standby mode, with activation of the cooking mode being immediately imminent. “Give off a warning signal” is to be understood in this context to mean a warning signal output, which is provided for an user of the cooking device, like in particular an optical, an acoustic and/or an additional warning signal output which appears to be significant to a person skilled in the art and/or a warning signal output which is routed to a further unit on the cooking device, like for instance on a extraction hood etc. The warning signal output unit here preferably has an optical output means, an acoustic output means and/or an output means, which is provided to give off electrical and/or electronic warning signals. In this context, an evaluation unit, a monitoring unit, a control unit and/or a regulation unit can be understood as a computation unit, with it being possible to form a computation unit both from a processor alone as well as in particular from a processor and further electronic components, like storage means. The computation unit also advantageously has the software needed to operate the cooking device.

Furthermore, it is recommended that the warning signal output unit is provided to give off a warning signal after cookware has been put back following a first time interval of the standby mode, as a result of which an unwanted warning signal output can be prevented by the warning signal output unit during a cooking process. In this way, a warning signal output can in particular be prevented in the case of a cooking process-specific, brief removal of cookware from a cooking zone. A “first time interval” is to be understood here as a short time interval, which preferably amounts to a maximum of 10 seconds and particularly advantageously to a maximum of 5 seconds. If the cookware is put back after the first time interval, a cooking process may already have been concluded and a renewed activation of the cooking mode may be unwanted in some instances, so that an user of the cooking device can be advantageously informed about an imminent, renewed activation of a cooking mode by means of the warning signal output unit.

The first time interval is advantageously smaller than a standby time interval in standby mode. The standby time interval can amount to a multiple of the first time interval, like for instance 90 seconds, so that a high safety standard is provided for preferably more than 75% and particularly advantageously more than 90% of the standby time interval.

Further components, installation space, assembly outlay and costs can be advantageously saved, if the warning signal output unit is at least partially embodied in one piece with the computation unit.

In a further embodiment of the invention, it is recommended that the cooking device has a unit, which is provided for a reactivation of a cooking mode, as a result of which the cooking mode and/or cooking process can be advantageously restarted for a user of the cooking device. The cooking mode is preferably reactivated by the unit after cookware is put back down, with it being possible for the reactivation to take place at least semi automatically and/or as a function of a user input. The unit may be advantageously embodied at least partially in one piece with an existing unit, like for instance the warning signal output unit and/or the computation unit and/or can be formed from a separate unit.

It is also recommended that the unit automatically reactivates the cooking mode within the first time interval after cookware is put down, as a result of which an unwanted interruption in the cooking mode and/or cooking process can be avoided for an user of the cooking device when removing and putting cookware down in the case of a brief and/or cooking process-specific removal. The cooking mode is preferably reactivated by means of the unit with unchanged settings, like in particular a setting with a selected heat output, so that it is easy to continue cooking.

The cooking device advantageously includes an input unit, which is provided to input a reactivation parameter of the cooking mode. As a result, increased safety can be achieved for a user of the cooking device, by this confirming a reactivation of the cooking mode by means of a reactivation parameter. If a reactivation parameter is absent as a result of an user of the cooking device, the cooking mode can also be in a deactivated state and the risk of overheating cookware can thus be advantageously anticipated. A reactivation parameter can be expediently input here after putting cookware down. Aside from a confirmation, the inputtable reactivation parameter can also be provided for functions which appear significant to the person skilled in the art, like in particular to set a standby interval, a setting of the warning signal etc.

It is also recommended that the unit reactivates the cooking mode with a reduced power, as a result of which the risk of overheated cookware and/or a fire in the contents of the cookware after cookware has been put down can be advantageously anticipated by a user of the cooking device. The heating power can be at least partially automatically reduced, particularly with very high settings, so that an output of a maximum power is avoided when empty cookware is put down for instance.

A particularly advantageous transmission of information to an user of the cooking device can be achieved by the warning signal output unit being provided to output a warning signal if the unit reactivates the cooking mode with the reduced power, with it being possible to output the warning signal prior to, during and/or after reactivation of the power.

It is also recommended that the warning signal output unit is provided to output warning signals for different cooking zones of a hob plate, as a result of which a high safety standard of the cooking device can be achieved during parallel operation with several cooking zones.

A method is also recommended, in particular with a cooking device, in which a standby mode is activated when cookware is removed, with a standby signal being output during the standby mode in at least one operating state. As a result, the cooking device user's safety and user-friendliness can be advantageously increased.

Further advantages result from the following description of drawings. Exemplary embodiments of the invention are shown in the drawings. The drawing, the description and the claims contain numerous combinations of features. The person skilled in the art also considers the features individually and combines them to form significant additional combinations, in which;

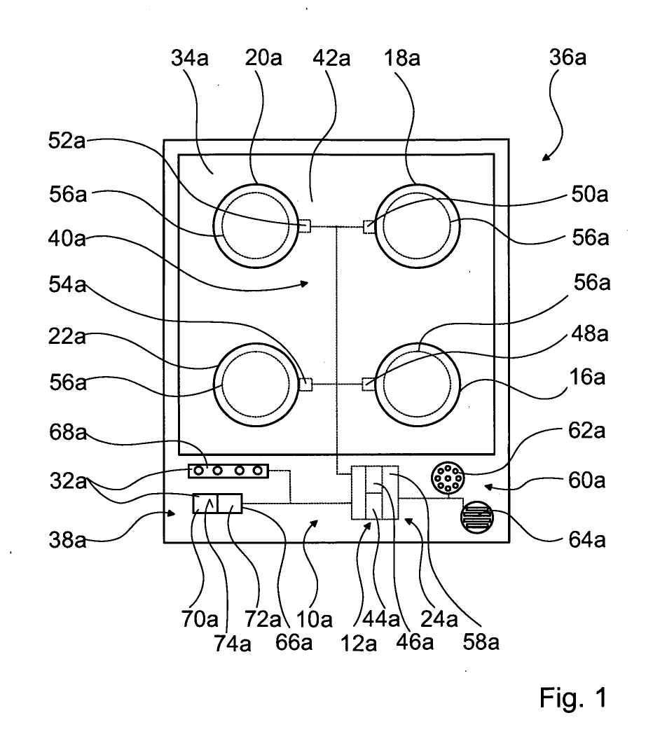

FIG. 1 shows a schematic representation from above of an induction hob with an inventive cooking device;

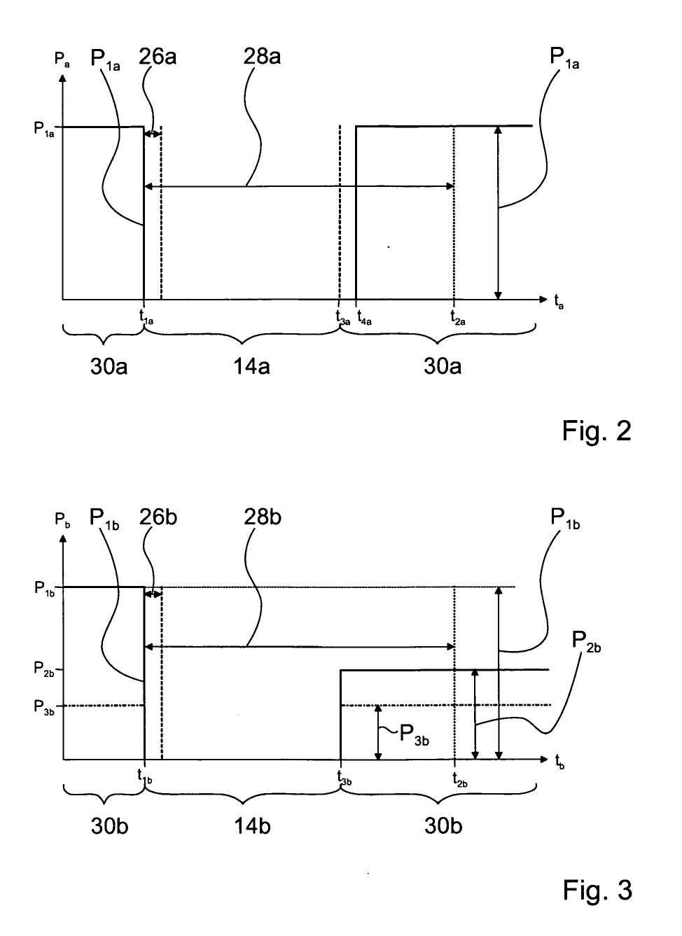

FIG. 2 shows a curve of an output power of a cooking zone over time and;

FIG. 3 shows an additional curve of an output power of a cooking zone over time.

FIG. 1 shows a view from above of an induction hob 36a with a hob plate 34a, which includes four circular cooking zones 16a, 18a, 20a, 22a. The induction hob 36a also includes an input field 38a and a cooking device 10a. The input field 38a is arranged in front of the hob plate 34a in the induction hob 36a from the view of a user of the induction hob 36a. A user of the induction hob 36a can actuate an input to control and/or regulate the individual cooking zones 16a, 18a, 20a, 22a by way of the input field 38a.

The cooking device 10a includes a unit embodied as a computation unit 12a, a sensor unit 40a, an input unit 32a and a warning signal output unit 24a. In addition, the cooking device 10a has an internal data line 42a, which is formed from a data cable and which connects the individual units with one another to form an internal data transport and/or data exchange. The internal data line 42a can essentially also be formed from a data bus and/or a wireless transmission, like in particular a radio connection. The computation unit 12a includes a processor 44a and a storage unit 46a, in which software required to operate the cooking device 10a and/or necessary operating programs as well as settings are stored for different operating functions of the cooking device 10a.

The sensor unit 46a has four sensor means 48a, 50a, 52a, 54a, which are each assigned to a cooking zone 16a, 18a, 20a, 22a of the induction hob 36a. The sensor means 48a, 50a, 52a, 54a are provided during operation of the cooking device 10a to identify cookware on one of the cooking zones 16a, 18a, 20a, 22a. To this end, each sensor means 48a, 50a, 52a, 54a is located adjacent to an induction coil 56a and is arranged below the hob plate 34a of the induction hob 36a.

Identifying cookware on one of the cooking zones 16a, 18a, 20a, 22a takes place by means of the sensor means 48a, 50a, 52a, 54a by way of measuring the current in the induction coils 56a. Further sensor means 48a, 50a, 52a, 54a which appear to be significant to the person skilled in the art are however also conceivable.

Data relating to the four sensor means 48a, 50a, 52a, 54a of the sensor unit 40a are routed during operation of the cooking device 10a via the internal data line 42a to the computation unit 12a and are evaluated there by means of the processor 44a and the necessary software, so that cookware on one of the cooking zones 16a, 18a, 20a, 22a is identified in a computation unit 12a. If cookware located on one of the cooking zones 16a, 18a, 20a,22a during operation of the cooking device 10a is removed from the cooking zone 16a, 18a, 20a, 22a by an user, for which cooking zone a cooking mode 30a is set, this is identified by the computation unit 12a together with the sensor unit 40a. The cooking mode 30a set for the cooking zone 16a, 18a, 20a, 22a is then automatically deactivated by the computation unit 12a and a standby mode 14a is automatically activated.

FIG. 2 shows a curve of an output power Pₐ for one of the cooking zones 16a, 18a, 20a, 22a with a first setting of the cooking device 10a over time tₐ. If at time t₁ₐ, cookware is removed from the cooking zone 16a, 18a, 20a, 22a, the computation unit 12a deactivates the cooking mode 30a set for the cooking zone 16a, 18a, 20a, 22a and/or a generation or output of a power P₁ₐ of the induction coil 56a is interrupted. The standby mode 14a is restricted to a standby time interval 28a of a maximum of 90 seconds. If no cookware is put back on the cooking zone 16a, 18a, 20a, 22a within the standby time interval 28a of the standby mode 14a, the cooking mode 30a for the corresponding cooking zone 16a, 18a, 20a, 22a and/or the cooking device 10a is automatically switched off by the computation unit 12a after the standby time interval 28a has concluded at time t₂ₐ. If by contrast cookware is placed on the cooking zone 16a, 18a, 20a, 22a within the standby time interval 28a of the standby mode 14a, the computation unit 12a is provided to reactivate the cooking mode 30a.

If cookware is put on the cooking zone 16a, 18a, 20a, 22a within a first time interval 26a of the standby time interval 28a, the computation unit 12a automatically reactivates the deactivated cooking mode 30a in order to avoid an unwanted interruption in the cooking process and/or to continue the cooking process by an user of the cooking device 10a and the standby mode 14a is automatically and promptly terminated. Settings of the cooking mode 30a prior to deactivation are undertaken here by the computation unit 12a for a renewed activation of the cooking mode 30a, so that a cooking process is continued with the unchanged power P₁ₐ of the induction coil 56a. The first time interval 26a is smaller here than the standby time interval 28a of the standby mode 14a and amounts to 5 seconds.

If cookware is put on the cooking zone 16a, 18a, 20a, 22a again after the first time interval 26a of the standby time interval 28a at a time instant t₃ₐ, a signal is first sent from the computation unit 12a, which is embodied in one piece with a base unit 58a of the warning signal output unit 24a, to an output unit 60a of the warning signal output unit 24a, which includes an optical output means 62a and an acoustic output means 64a. The optical output means 62a and the acoustic output means 64a are connected to the base unit 58a by way of the internal data line 42a.

The warning signal output unit 24a provides an optical and/or an acoustic warning signal for an user, which can be set by an user, once cookware is put back on the cooking zone 16a, 18a, 20a, 22a within the standby mode 14a by way of the optical output means 62a and/or the acoustic output means 64a. The warning signal informs the user of the cooking device 10a that he/she has put cookware on a cooking zone 16a, 18a, 20a, 22a, which is in standby mode 14a and that the cooking device 10a is also in operation. In addition, the user is then requested by means of the output warning signal to input a reactivation parameter of the cooking mode 30a and/or the cooking zone 16a, 18a, 20a, 22a by way of the input unit 32a.

The input unit 32a is arranged in a region of the input field 38a and includes a touch-sensitive input field 66a and an optical output means 68a. In addition, the input unit 32a is connected to the computation unit 12a by way of the internal data line 42a. The touch-sensitive input field 66a is subdivided into two sub regions 70a, 72a, with each of the two sub regions 70a, 72a having a touch-sensitive sensor (not shown in more detail) which is arranged below an input surface 74a. The first sub region 70a is provided to activate an input mode of the input unit 32a for one of the cooking zones 16a, 18a, 20a, 22a in each instance. The second sub region 72a is provided for a menu selection for the cooking zones 16a, 18a, 20a, 22a which are already activated by means of the input unit 32a, by way of which a user can select and/or set different cooking modes 30a. Further input means which appear significant to the person skilled in the art, like for instance a rotary switch, button etc. are however essentially also conceivable at any time in an alternative embodiment of the inventive device.

To input the reactivation parameter, the input unit 32a is firstly activated by the user during operation of the cooking device 10a for the corresponding cooking zone 16a, 18a, 20a, 22a and the reactivation parameter is then input. Once the reactivation parameter has been input, the cooking mode 30a of the corresponding cooking zone 16a, 18a, 20a, 22a is reactivated by the computation unit 12a at a time instant t₄ₐ and the standby mode 14a is promptly terminated. The time instant t₄ₐ of the reactivation is slightly after the time instant t₃ₐ of the renewed positioning of cookware on the cooking zone 16a, 18a, 20a, 22a. Settings of the cooking mode 30a before deactivation are undertaken here by the computation unit 12a for a reactivation of the cooking mode 30a, so that a cooking process is continued with the unchanged output power P₁ₐ. If a reactivation parameter is absent as a result of the user of the cooking device 10a, once the standby time interval 28a has concluded, the cooking mode 30a is automatically switched off for the corresponding cooking zone 16a, 18a, 20a, 22a and/or the cooking device 10a by the computation unit 12a. The cooking device 10a and/or the warning signal output unit 24a ensure a parallel output of optical and/or acoustic warning signals for each cooking zone 16a, 18a, 20a, 22a and thus a high safety level in terms of the cooking device 10a.

FIG. 3 shows an alternative curve of an output power P_{b} of a cooking zone 16b, 18b, 20b, 22b with a second setting over a time t_{b}. Essentially corresponding components and features are basically provided with the same reference characters, with the letters a (FIGS. 1 and 2) and b (FIG. 3) being added to the reference characters to make a distinction between the exemplary embodiments. Reference can be made to the description of the exemplary embodiment in FIGS. 1 and 2 in respect of the identical features and functions. The description which follows in FIG. 3 is essentially restricted to the differences in the exemplary embodiments in FIGS. 1 and 2.

A power P_{1b} output by the cooking zone 16b, 18b, 20b, 22b and/or an induction coil 56b is automatically set by a computation unit 12b when cookware is removed from the cooking zone 16b, 18b, 20b, 22b at time instant t_{1b} and/or a selected cooking mode 30b of the cooking zone 16b, 18b, 20b, 22b is deactivated and a standby mode 14b is activated for the corresponding cooking zone 16b, 18b, 20b, 22b. When cookware is put back on the cooking zone 16b, 18b, 20b, 22b at time instant t_{3b} within a standby time interval 28b, with the time instant t_{3b} lying after a first time interval 26b, the deactivated cooking mode 30b is automatically reactivated by the computation unit 12b and the standby mode 14b is terminated promptly. To prevent cookware from overheating, in particular empty cookware, and/or the danger associated therewith for a user of a cooking device 10b, an output power P_{1b} of the induction coil 56b is automatically reduced by the computation unit 12b. A reduced, output power P_{2b} takes place in the case of settings of the cooking mode 30b, which provide a high output power P_{1b} of the induction coil 56b, with the output power P_{1b} amounting to at least 50% of a maximum power of the cooking zone 16b, 18b, 20b, 22b. The power P_{2b} output after reactivation and power reduction amounts to half of the previously set power P_{1b}. With settings of the cooking mode 30b, which provide a minimal output power P_{3b} of the induction coil 56b, a reduction in the output power P_{3b} is omitted.

Parallel to reducing the output power P_{2b}, an optical and/or acoustic warning signal is output for a user of the cooking device 10b, which can be set by a user, by means of an optical output means 62b and/or an acoustic output means 64b of a warning signal output unit 24b. The output warning signal informs the user of the cooking device 10b that he/she has placed cookware on a cooking zone 16b, 18b, 20b, 22b in standby mode 14b and a set and deactivated cooking mode 30b of the relevant cooking zone 16b, 18b, 20b, 22b is automatically activated with reduced power and/or the standby mode 14b is terminated.

### REFERENCE CHARACTERS

10 Cooking device

12 Computation device

14 Standby mode

16 Cooking zone

18 Cooking zone

20 Cooking zone

22 Cooking zone

24 Warning signal output unit

26 Time interval

28 Standby time interval

30 Cooking mode

32 Input unit

34 Hob plate

36 Induction hob

38 Input field

40 Sensor unit

42 Data line

44 Processor

46 Storage unit

48 Sensor means

50 Sensor means

52 Sensor means

54 Sensor means

56 Induction coil

58 Base unit

60 Output unit

62 Output means

64 Output means

66 Input field

68 Output means

70 Sub region

72 Sub region

74 Input surface

P Power

P₁ Power

P₂ Power

P₃ Power

t Time

t₁ time instant

t₂ time instant

t₃ time instant

t₄ time instant

1-10. (canceled)

11. A cooking device, in particular a cooking device for induction hobs, the cooking device comprising:
a computation unit, the computation unit having at least one standby mode that is activated as a function of a removal of cookware from a cooking zone; and
a warning signal output unit, the warning signal output unit outputting, during a period in which the standby mode has been activated, a warning signal in the event that cookware is again within the cooking zone.

12. The cooking device according to claim 11 wherein the warning signal output unit is configured to emit a warning signal after cookware has been returned to the cooking zone after a first time interval associated with the standby mode.

13. The cooking device according to claim 11 wherein the warning signal output unit is at least partially embodied in one piece with the computation unit.

14. The cooking device according to claim 11 and further comprising a reactivation unit configured for reactivation of a cooking mode.

15. The cooking device according to claim 12 wherein the reactivation unit automatically reactivates the cooking mode within a first time interval after cookware is returned to the cooking zone.

16. The cooking device according to claim 14 and further comprising an input unit which configured to input a reactivation parameter of the cooking mode.

17. The cooking device according to claim 14 wherein the reactivation unit reactivates the cooking mode with a reduced power P_{b}.

18. The cooking device according to claim 17 wherein the warning signal output unit is configured to output a warning signal when the reactivation unit reactivates the cooking mode with the reduced power P_{b}.

19. The cooking device according to claim 11 wherein the cooking device includes a hob plate and wherein the cooking device further comprises a warning signal output unit configured to output warning signals for different cooking zones of the hob plate.

20. A method for using a cooking device comprising the steps of:
providing a cooking device having a computation unit, the computation unit having at least one standby mode that is activated as a function of a removal of cookware from a cooking zone; and a warning signal output unit, the warning signal output unit outputting, during a period in which the standby mode has been activated, a warning signal in the event that cookware is again within the cooking zone; and
activating a standby mode when cookware is removed wherein a warning signal is output during the standby mode in at least one operating state.
